(19) United States
(12) Patent Application Publication
(10) Pub. No.: US 2024/0340123 A1
(43) Pub. Date: Oct. 10, 2024

(54) RESOURCE ALLOCATION IN DATA COMMUNICATIONS SYSTEMS

(71) Applicant: QUALCOMM Incorporated, San Diego, CA (US)

(72) Inventors: Weimin DUAN, San Diego, CA (US); Alexandros MANOLAKOS, Athens, Attikí (GR); Krishna Kiran MUKKAVILLI, San Diego, CA (US)

(21) Appl. No.: 18/700,063

(22) PCT Filed: Nov. 14, 2022
(86) PCT No.: PCT/US2022/079789

§ 371 Date: Apr. 10, 2024

(30) Foreign Application Priority Data
Dec. 15, 2021 (GR) 20210100884

(51) Int. Cl. H04L 5/00; G01S 7/00; H04B 1/713; H04B 7/0413

(52) U.S. Cl. CPC H04L 5/0007; G01S 7/006; H04B 1/713; H04B 7/0413; H04L 5/0053

(57) ABSTRACT

Methods and apparatus for resource allocation for radio frequency (RF) sensing signals in data communications systems are provided. In some embodiments, a transmitter may determine one or more capabilities associated with a multiple input, multiple output (MIMO) antenna of the transmitter, send information relating to the capabilities to a network entity (e.g., server) of the network, obtain configuration data relating to an allocation of frequency resources for a RF sensing signal (e.g., radar reference signal) interleaved with respect to a plurality of antenna ports associated with the MIMO antenna, and transmit the RF sensing signal in accordance with the configuration data. The obtained data may be configured based on the capabilities. The frequency resources may be orthogonal frequency-division multiplexing (OFDM) resources. According to different embodiments, allocation of OFDM resources may be equidistant, non-equidistant, or on demand (e.g., as requested by the server or confirmed by the server).

### BACKGROUND

### 1. Field of Disclosure

The present disclosure relates generally to the field of wireless communications, and more specifically to allocation of positioning reference signals (e.g., radio frequency (RF) sensing signals) in frequency spectra that are occupied by signals used for wireless data communication.

### 2. Description of Related Art

Radio access technologies (RATs) continue to become available for widespread public use and progress through research (e.g., Fifth Generation New Radio (5G NR) and beyond). These advancements in cellular data communications systems demand greater bandwidth and greater spectrum efficiency for delivering larger amounts of data at higher speeds.

### BRIEF SUMMARY

In one aspect of the present disclosure, a method of allocating resources for radio frequency (RF) sensing by a transmitter of a network is disclosed. In some embodiments, the method includes: determining one or more capabilities associated with a multiple input, multiple output (MIMO) antenna of the transmitter of the network; sending, to a network entity of the network, information relating to the one or more capabilities associated with the MIMO antenna; obtaining configuration data relating to an allocation of frequency resources for an RF sensing signal; and transmitting the RF sensing signal in accordance with the configuration data.

In another aspect of the present disclosure, a base station is disclosed. In some embodiments, the base station includes a transmitter, the transmitter comprising a multiple input, multiple output (MIMO) antenna; memory; and one or more processors communicatively coupled to the memory and the transmitter, and configured to: determine one or more capabilities associated with the MIMO antenna of the transmitter; send, to a network entity of a network, information relating to the one or more capabilities associated with the MIMO antenna; obtain configuration data relating to an allocation of frequency resources for an RF sensing signal; and transmit the RF sensing signal in accordance with the configuration data.

In another aspect of the present disclosure, a method of allocating resources for radio frequency (RF) sensing within a network is disclosed. In some embodiments, the method includes: receiving, from a transmitter of the network, information relating to one or more capabilities associated with a multiple input, multiple output (MIMO) antenna of the transmitter; determining an allocation of frequency resources for an RF sensing signal; and sending, to the transmitter, data relating to the determined allocation.

In another aspect of the present disclosure, a computerized network apparatus is disclosed. In some embodiments, the computerized network apparatus includes: one or more network interfaces configured to perform data communication with a transmitter of a network; memory; and one or more processors communicatively coupled to the memory and the one or more network interfaces, and configured to: receive, from the transmitter of the network, information relating to one or more capabilities associated with a multiple input, multiple output (MIMO) antenna of the transmitter; determine an allocation of frequency resources for an RF sensing signal; and send, to the transmitter, data relating to the determined allocation.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a block diagram of a radar system performing radar-based directional proximity sensing, according to an embodiment.

FIG. 4 is a diagram showing the basic operation of a bistatic radar system, according to an embodiment.

FIG. 5 illustrates the implementation of a bistatic radar system in a wireless communications system, according to an embodiment.

FIG. 6 is a diagram showing an example of a frame structure for NR and associated terminology.

FIG. 7 is a diagram showing a first example allocation of OFDM resources to antenna ports of a transmitter configured for multiple input, multiple out (MIMO) transmission.

FIGS. 8A and 8B are block diagrams illustrating the effect of a location of an object on the unambiguously measurable range of a target object.

FIG. 9 is a diagram showing a second example allocation of OFDM resources to antenna ports of a transmitter configured for MIMO transmission.

FIG. 10 is a flow diagram of a method of allocating resources for communication by a transmitter of a network, according to some embodiments.

FIG. 11 is a flow diagram of a method of allocating resources for communication within a network, according to some embodiments.

FIG. 12 is a block diagram of an embodiment of a base station, which can be utilized in embodiments as described herein.

FIG. 13 is a block diagram of an embodiment of a UE, which can be utilized in embodiments as described herein.

FIG. 14 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 101 may be indicated as 101-1, 101-2, 101-3 etc. or as 101a, 101b, 101c, etc. When referring to such an element using only the first number, any instance of the element is to be understood (e.g., element 101 in the previous example would refer to elements 101-1, 101-2, and 101-3 or to elements 101a, 101b, and 101c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

Additionally, references to “reference signals,” “positioning reference signals,” “reference signals for positioning,” and the like may be used to refer to signals used for positioning of a user equipment (UE) or other objects. As described in more detail herein, such signals may comprise any of a variety of signal types but may not necessarily be limited to a Positioning Reference Signal (PRS) as defined in relevant wireless standards.

Given the increasing demands placed on data communications, there is room to improve the efficiency of positioning systems. For instance, when positioning based on RF (e.g., radar) signals, there is an opportunity for efficient spectrum allocation, where RF sensing reference signals and data communications signals may be jointly communicated. In particular, Orthogonal Frequency-Division Multiplexing (OFDM) waveform (and/or its variants) may considered as the basis for such joint data communication and RF-based sensing. OFDM waveforms continue to be utilized for high-throughput data communications and RATs (e.g., 5G NR networks), and hence, higher efficiency of OFDM resources are desired. One solution is to perform joint communication of data and RF sensing signals at the symbol level to increase the spectrum efficiency of communications networks that utilize RF sensing systems. In one aspect, capabilities relating to the transmitter may be used to determine an allocation scheme for resource elements (REs) and/or resource blocks (RBs). Efficient joint communication may also account for capabilities of antennas (e.g., multiple in, multiple out (MIMO) capability, number of antenna ports). Additional details will follow after an initial description of relevant systems and technologies.

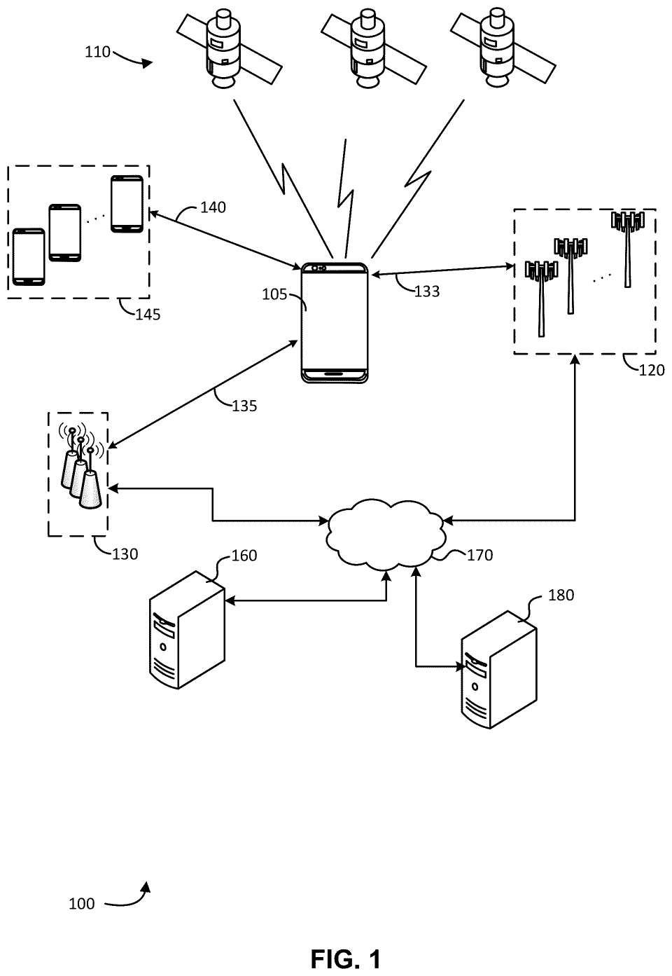

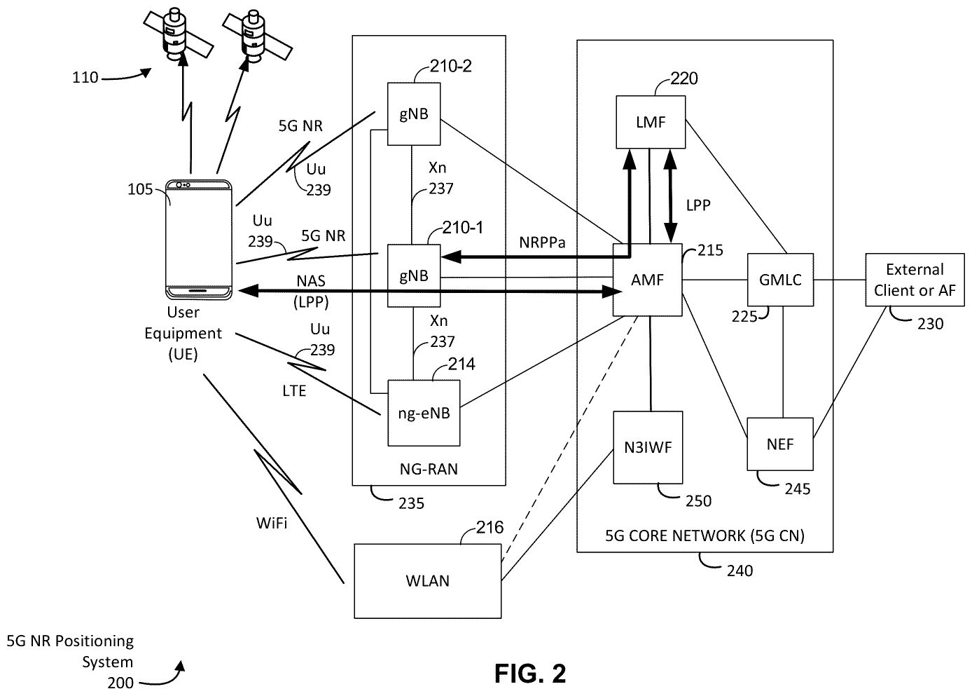

FIG. 1 is a simplified illustration of a positioning system 100 in which a UE 105, location server 160, and/or other components of the positioning system 100 can use the techniques provided herein for allocating resources for RF reference signals (e.g., radar reference signals) so as to multiplex said reference signals with data communications signals, according to various embodiments. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIGS. 2-5.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be configured to be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., BS 120 or AP 130) or some other location such as a location for UE 105 at some known previous time, or a location of another UE 145). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes 210, 214, 216 (which may correspond with base stations 120 and access points 130 of FIG. 1) and (optionally) an LMF 220 (which may correspond with location server 160) to implement one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235, e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node 210, 214, or 216 of a first RAT to an access node 210, 214, or 216 of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

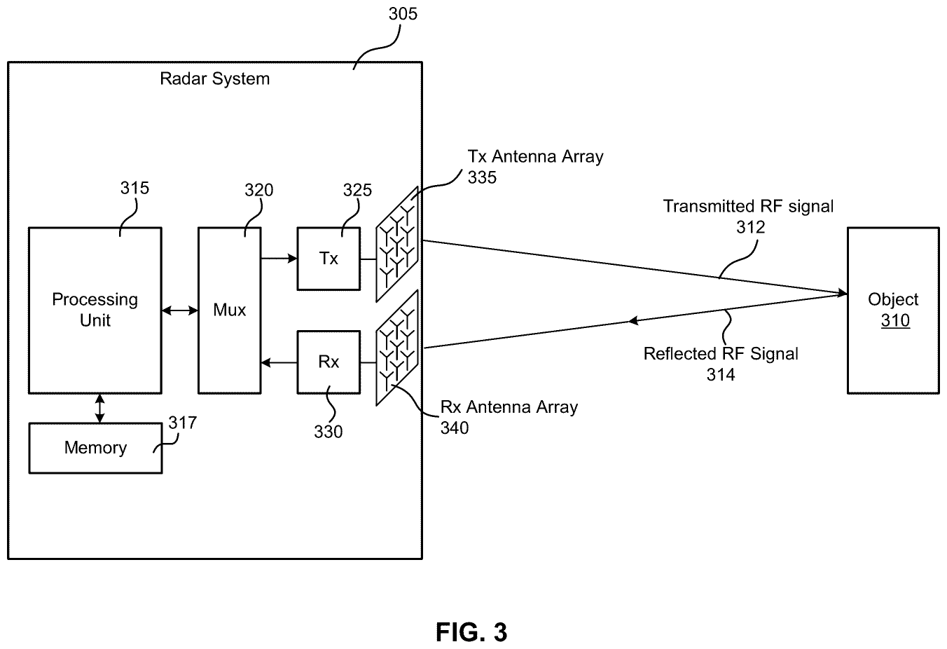

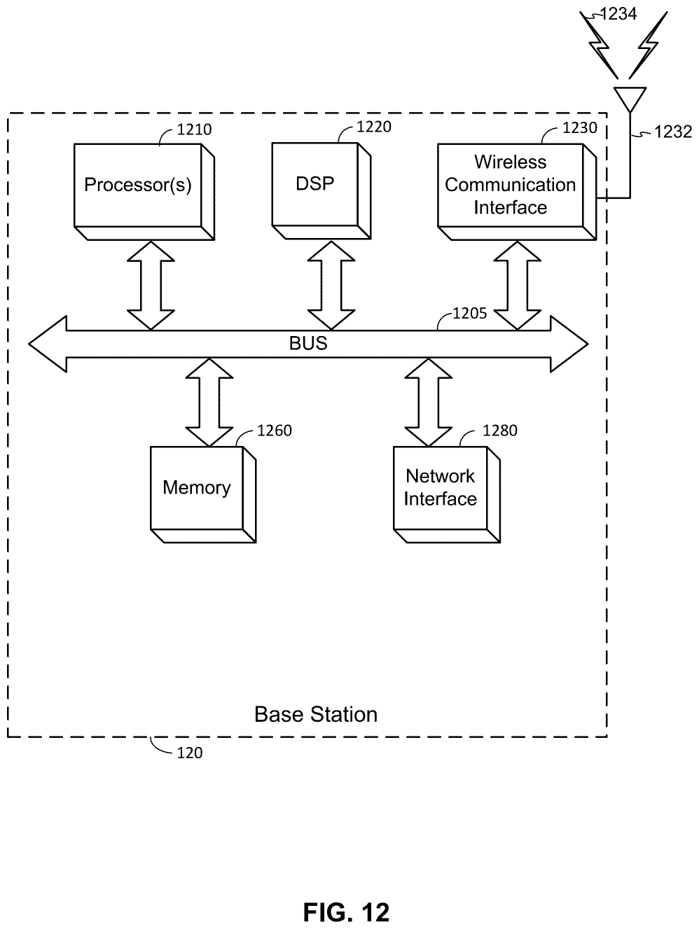

FIG. 3 is a block diagram of a radar system 305 performing radar-based directional proximity sensing, according to an embodiment. As used herein, the terms “waveform” and “sequence” and derivatives thereof are used interchangeably to refer to RF signals generated by a transmitter of the radar system and received by a receiver of the radar system for object detection. A “pulse” and derivatives thereof are generally referred to herein as waveforms comprising a sequence or complementary pair of sequences transmitted and received to generate a channel impulse response (CIR). The radar system 305 may comprise a standalone device or may be integrated into a larger electronic device, such as a mobile phone or other device. Example components of such an electronic device are illustrated in FIGS. 12-14 and discussed in detail hereafter.

With regard to the functionality of the radar system 305 in FIG. 3, the radar system 305 can detect the proximity of an object 310 by generating a series of transmitted RF signals 312 (comprising one or more pulses). Some of these transmitted RF signals 312 reflect off of the object 310, and these reflected RF signals 314 are then processed by the radar system 305 using beamforming (BF) and digital signal processing (DSP) techniques (including leakage cancellation) to determine the object's location (azimuth, elevation, velocity, and range) relative to the radar system 305. Because embodiments may implement a flexible field of view (FOV), the radar system 305 can detect an object 310 within a select volume of space. This volume of space can be defined by a range of azimuths, elevations, and distances from the radar system 305. (As described below, this volume of space may also be defined by an FOV (a range of azimuths and elevations) and a range of distances within the FOV or from an area of interest corresponding to the FOV.)

To enable radar proximity detecting radar system 305 includes a processing unit 315, memory 317, multiplexer (mux) 320, Tx processing circuitry 325, and Rx processing circuitry 330. The radar system 305 may include additional components not illustrated, such as a power source, user interface, or electronic interface. It can be noted, however, that these components of the radar system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively, but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitry) for leakage cancellation as described herein. Other processing of the CIR may also be performed, such as object detecting, range, speed, or direction of arrival (DoA) estimation.

BF is further enabled by a Tx antenna array 335 and Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the radar system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHZ). That said, some embodiments may utilize radar with frequencies outside this range. For example, in some embodiments, 5G frequency bands (e.g., 28 GHz) may be used. Because radar may be performed in the same busy bands as communication, hardware may be utilized for both communication and radar sensing, as previously noted. For example, one or more of the components of the radar system 305 shown in FIG. 3 may be included in a wireless modem (e.g., Wi-Fi or 5G modem). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the radar system may be capable of sending RF signals for communication (e.g., using 802.11 communication technology), embodiments may leverage channel estimation used in communication for performing proximity detection as provided herein. Accordingly, the pulses may be the same as those used for channel estimation in communication.

As noted, the radar system 305 may be integrated into an electronic device in which proximity detecting is desired. For example, the radar system 305, which can perform radar-based proximity detecting, may be part of communication hardware found in modern mobile phones. Other devices, too, may utilize the techniques provided herein. These can include, for example, other mobile devices (e.g., tablets, portable media players, laptops, wearable devices, virtual reality (VR) devices, augmented reality (AR) devices), as well as other electronic devices (e.g., security devices, on-vehicle systems). That said, electronic devices into which a radar system 305 may be integrated are not limited to mobile devices. Furthermore, radar-based proximity sensing as described herein may be performed by a radar system 305 that may not be otherwise used in wireless communication.

Although capable of providing a high degree of accuracy, directional proximity sensing shown in FIG. 3, if performed frequently, can be problematic in certain applications. For example, to perform a scan for a nearby object 310 the radar system 305 may transmit a large number of transmitted RF signals 312 such that each antenna element in the Rx antenna array 340 receives a reflected RF signal 314 corresponding to a transmitted RF signal 312 transmitted from each antenna element in the Tx antenna array 335. Moreover, the radar system 305 may perform a scan very frequently (e.g., several times per second). And thus, the directional proximity sensing performed by the radar system 305 may consume a large amount of power. This may be problematic for low-power applications.

According to embodiments described herein, radar-based directional proximity sensing techniques can be implemented to help reduce the power consumption used in directional radar sensing. In particular, according to some embodiments, a radar system can first operate in a low-power, omnidirectional proximity sensing mode in which signals are transmitted having no directionality. Once an object is detected, the radar system can then operate in a higher-power directional proximity sensing mode to provide accurate directional detection capabilities in the desired FOV.

The above-described radar-based sensing techniques may be described as a “monostatic” radar system, in which the transmitter 325 and receiver 330 are collocated. In contrast, a monostatic radar may be distinguished from a bistatic or multi-static radar system, described below.

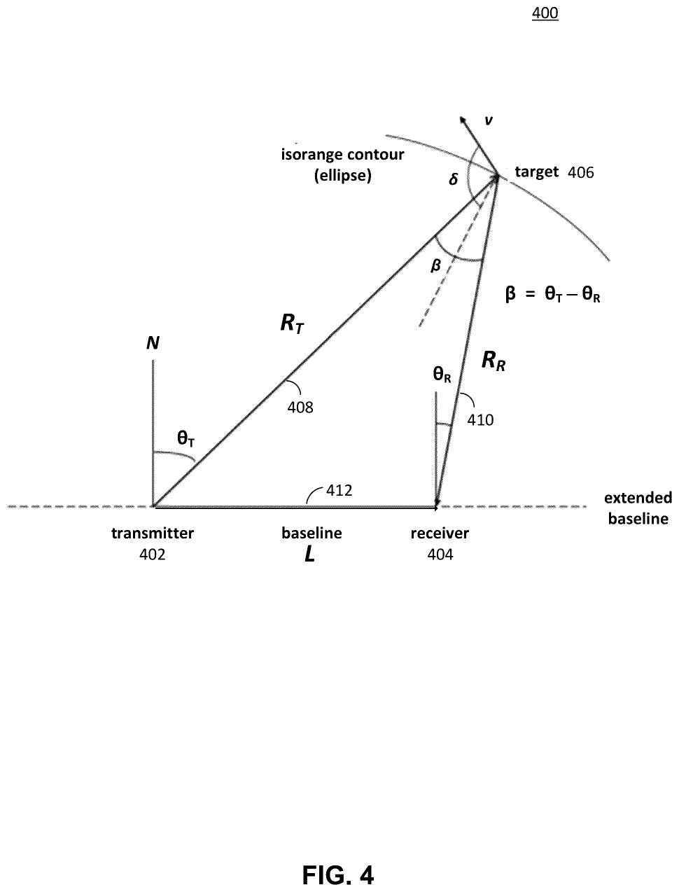

FIG. 4 is a simplified diagram showing the basic operation of a bistatic radar system 400. A transmitter 402 and a receiver 404 are used to send and receive radar signals for sensing a target 406. While a bistatic radar example is shown, the same principals of operation can be applied to a multi-static radar, which utilizes more than two transmitter(s)/receiver(s). For example, a multi-static radar may utilize one transmitter and two receivers. In another example, a multi-static radar may utilize two transmitters and one receiver. Larger numbers of transmitters and/or receivers may also be possible.

In bistatic radar system 400, the transmitter 402 sends a transmit signal 408 which traverses a distance R_{T} to reach target 406. The transmit signal 408 reflects from the target 406 and becomes an echo signal 410 which traverses a distance R_{R} to reach the receiver 404. A primary function served by bistatic radar system 400 is sensing the range, or distance R_{R}, from the target 406 to the receiver 404. The system determines the range R_{R} primary by sensing the amount of time taken for the transmit signal 408 and echo signal 410 to traverse the total distance Rₛᵤₘ, which is the sum of R_{T} and R_{R}:

$$\\ \begin{matrix}{R}_{sum} = {R}_{T} + {R}_{R} & ( Eq . 1 )\end{matrix}$$

The total distance Rₛᵤₘ defines an ellipsoid surface (also known as the iso-range contour) with foci at the locations of the transmitter 402 and the receiver 404, respectively. The ellipsoid surface represents all the possible locations of the target 406, given the total distance Rₛᵤₘ. The radar system 400 is capable of measuring the distance Rₛᵤₘ. For example, if perfect synchronization of timing between the transmitter 402 and the receiver 404 can be assumed, it would be easy to simply measure the time duration Tₛᵤₘ between moment when the transmitter 402 sent the transmit signal 408 and moment when the receiver 404 received the echo signal 410. Multiplying the time duration Tₛᵤₘ by the speed of the signal through free space, e.g., approximately c=3*10⁸ meters/second, would yield Rₛᵤₘ. Thus, the ellipsoid surface of all possible locations of the target 406 can be found by measuring the “flight time” Tₛᵤₘ of the bistatic radar signal.

According to some embodiments, the distance Rₛᵤₘ can be measured without tight time synchronization between the transmitter 402 and the receiver 404. In one embodiment, a line-of-sight (LOS) signal 412 can be sent from the transmitter 402 to the receiver 404. That is, at the same time that transmitter 402 sends the transmit signal 408 toward the target 406, transmitter 402 may also send the LOS signal 412 toward the receiver 404. According to a specific embodiment, the transmit signal 408 may correspond to a main lobe of a transmit antenna beam pattern emitted from the transmitter 402, while the LOS signal 412 corresponds to a side lobe of the same transmit antenna beam pattern emitted from transmitter 402.

The receiver 404 receives both the echo signal 410 and the LOS signal 412 and can utilize the timing of the reception of these two signals to measure the total distance Rₛᵤₘ, using the expression:

$$\\ \begin{matrix}{R}_{sum} = ( {T}_{Rx \_ echo} - {T}_{{Rx}_{LOS}} ) * c + L & ( Eq . 2 )\end{matrix}$$

Here, T_{Rx_echo} is the time of reception of the echo signal 410. T_{RxLOS} is the time of reception of the LOS signal 412. As mentioned, c=3*10⁸ meters/second is the speed of the signal through free space. L is the distance between the transmitter 402 and the receiver 404. Once Rₛᵤₘ is found, it can be used to calculate the target range R_{R}, i.e., the distance between the target 406 and the receiver 404, using the following expression:

$$\\ \begin{matrix}{R}_{R} = \frac{{R}_{sum}^{{}_{} 2} - {L}^{{}_{} 2}}{2 ( {R}_{sum} + L * sin {θ}_{R} )} & ( Eq . 3 )\end{matrix}$$

The bistatic radar system 400 can also be used to determine the angle of arrival (AoA) θ_{R} at which the echo signal 410 is received by receiver 404. This can be done in various ways. One way is to estimate θ_{R} by using an antenna array at the receiver 404. An antenna array, which comprises multiple antenna elements, can be operated as a programmable directional antenna capable of sensing the angle at which a signal is received. Thus, the receiver 404 may employ an antenna array to sense the angle of arrival of the echo signal 410. Another way to estimate θ_{R} involves multilateration. Multilateration refers to the determination of the intersection of two or more curves or surfaces that represent possible locations of a target. For example, the bistatic radar system 400 shown in FIG. 4 can define a first ellipsoid surface representing possible locations of the target 406, as described previously. A second bistatic radar system with a differently located transmitter and/or receiver can define a second, different ellipsoid surface that also represents the possible locations of the target 406. The intersection of the first ellipsoid surface and the second ellipsoid surface can narrow down the possible location(s) of the target 406. In three-dimensional space, four such ellipsoid surfaces would generally be needed to reduce the possible location to a single point, thus identifying the location of target 406. In two-dimensional space (e.g., assuming all transmitters, receivers, and the targets are confined to the being on the ground), three such ellipsoid surfaces (for two-dimensional space, the ellipsoid surfaces reduce to elliptical curves) would generally be needed to reduce the possible locations to a single point, thus identifying the location of target 406. Multilateration can also be achieved in a similar manner using multi-static radar system instead of multiple bistatic radar systems.

Furthermore, the bistatic radar system 400 can also be used to determine the Doppler frequency associated with the target 406. The Doppler frequency denotes the relative velocity of the target 406, from the perspective of the receiver 404—i.e., the velocity at which the target 406 is approaching/going away from the receiver 404. For a stationary transmitter 402 and a stationary receiver 404, the Doppler frequency of the target 406 can be calculated as:

$$\\ \begin{matrix}{f}_{D} = \frac{2 v}{c} * cos δ * cos ( β / 2 ) & ( Eq . 4 )\end{matrix}$$

Here, fb is the Doppler frequency, v is the velocity of the target 406 relative to a fixed frame of reference defined by the stationary transmitter 402 and receiver 404. β is the angle formed between the transmit signal 408 and the echo signal 410 at the target 406. δ is the angle between the velocity vector v and the center ray (half angle) defined within angle β.

In FIG. 4, a fixed frame of refence is defined with respect to the stationary transmitter 402 and stationary receiver 404. Specifically, a baseline of length L can be drawn between the transmitter 402 and the receiver 404. The baseline can be extended beyond the transmitter 402 and receiver 404. One or more normal lines can be drawn as being perpendicular to the baseline. A transmit angle θ_{T} can be defined relative to a normal line drawn from the location of the transmitter 402. A receive angle θ_{R}, referred to above as the angle of arrival, can be defined relative to a normal line drawn from the location of the receiver 404.

As mentioned previously, bistatic radar system 400 can be operated to sense a target in two-dimensional space or three-dimensional space. An additional degree of freedom is introduced in the case of three-dimensional space. However, the same basic principles apply, and analogous calculations may be performed.

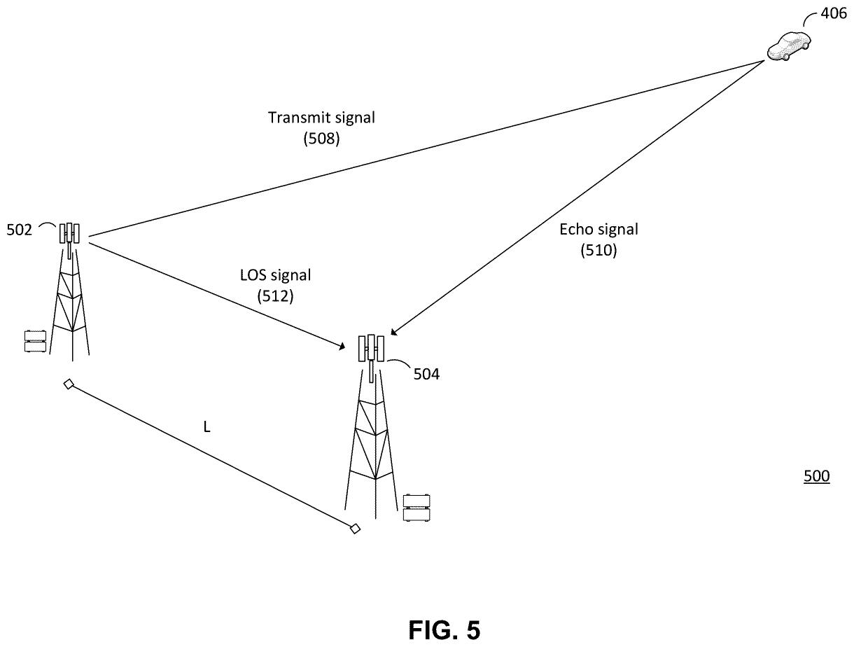

FIG. 5 illustrates the implementation of the bistatic radar system in a wireless communications system, according to an embodiment of the disclosure. The wireless communications system may comprise a cellular communication system 500, as shown in FIG. 5. The cellular communications system 500 may comprise numerous Transmission Reception Points (TRPs), which provide transmission and/or reception of signals with other devices. Examples of TRPs within the cellular communications system 500 include base stations 502 and 504, which serve to provide cellular communications for user equipment (UE) such as vehicles, wireless phones, wearable device, personal access points, and a plethora of other types of user devices in the vicinity that require wireless data communications. For instance, base stations 502 and 504 may be configured to support data communications with a UE device, by transmitting data symbols to or receiving data symbols from the UE device. Resources within the cellular communication system 500, such as base station 502 and 504, may thus be utilized to serve “double duty” to support not only cellular communication operations but also bistatic and/or multi-static radar operations.

For example, base stations 502 and base station 504 may serve as the transmitter 402 and receiver 404, respectively, of the bistatic radar system 400 shown in FIG. 4. Base station 502 may transmit the transmit signal 508, which reflects from target 406 and becomes the echo signal 510 received by the base stations 504. The base station 504 may also receive a line-of-sight (LOS) signal 512 from the base station 502. By receiving both the LOS signal 512 and the echo signal 510, the RX base station 504 can measure the value associated with the time difference between the reception times T_{Rx_echo} and T_{RxLOS} associated with the reception of the echo signal 510 and the LOS signal 512, respectively. For example, the RX base station 504 may cross-correlate the received LOS signal 512 with the received echo signal 510, such as by mixing the two signals in analog or digital form, to yield a value representative of the time difference (T_{Rx_echo}−T_{RxLOS}). The time difference can be used to find the total distance Rₛᵤₘ. The total distance Rₛᵤₘ can then be used to define an ellipsoid surface, which along with other information may be used to find the target range R_{R}, angle of arrival (AoA) θ_{R}, and/or Doppler frequency associated with the target 506, using one or more techniques discussed previously with respect to FIG. 1.

Here, target 406 may be, but does not have to be, a UE that is being supported by the cellular communications system 500. In some instances, target 406 may be a UE that is configured to transmit and receive wireless signals carrying voice, text, and/or wireless data using the base stations of cellular communications system 500. In other instances, target 406 may simply be a remote object that is within the bistatic radar range of base station 502 and base station 504 but otherwise has nothing to do with the cellular communications functions of system 500.

In the bistatic example shown in FIG. 5, the transmitter is referred to as the TX base station 502, and the receiver is referred to as the RX base station 504. More generally, TX base station 502 may be referred to as a TX TRP, and RX base station 504 may be referred to as a RX TRP. Here “TX” and “RX” merely refer to the fact that base station 502 is used to transmit the radar transmission signal 508, and the base station 504 is used to receive the radar echo signal 510. The terms “TX” and “RX” in this context do not limit the operation of the base stations 502 and 504 to serve other functions, e.g., to serve as transmitter and/or receiver in other bistatic or multi-static radar operations (beyond what is illustrated in FIG. 5) or as base stations transmitting and receiving data communications in the normal operation of the cellular communications system 500. While FIG. 5 illustrates a simple bistatic radar system, a multi-static radar system may also be implemented within a cellular communications system in a similar manner. Also, while FIG. 5 illustrates a simple example in two-dimensional space, the same operations can be extended to three-dimensional space.

Implementing a bistatic or multi-static radar system within a cellular communications system according to embodiments of the present disclosure may yield numerous benefits. One particular benefit is the flexible utilization of bandwidth allocated for cellular communications. For example, according to one embodiment, the cellular communications system 500 may conform to the 5G standard introduced in the release 15 version of the 3rd Generation Partnership Project (3GPP) specifications. Ever increasing bandwidth allotted to present and future cellular communications systems, including 5G and 5G beyond, may be leveraged for the transmission of bistatic and multi-static radar signals. Thus, radio frequency (RF) sensing (e.g. radar) may be enabled by utilizing available cellular RF spectrum resource. For example, one or more of the transmit signal 508, echo signal 510, and/or LOS signal 512 may occupy bandwidth within a portion of radio frequency (RF) spectrum allocated to the cellular communications system 500 for data communications.

Also, the inherent benefits of bistatic and multi-static radar systems can be realized by an existing, widespread network of well-positioned transmitters and receivers, in the form of cellular base stations. Compared with a monostatic radar system, a bistatic or multi-static radar system mitigates against self-interference by having physically separated transmitter equipment and receiver equipment. Cellular base stations, such as base stations 502 and 504 shown in FIG. 5, already exist and cover vast geographic areas where users, vehicles, and other objects of interest are likely to appear. Such cellular base stations are well-dispersed, and as a result, provide opportunities for the selection of appropriately located base stations to serve as transmitters and receivers for bistatic and multi-static radar operations.

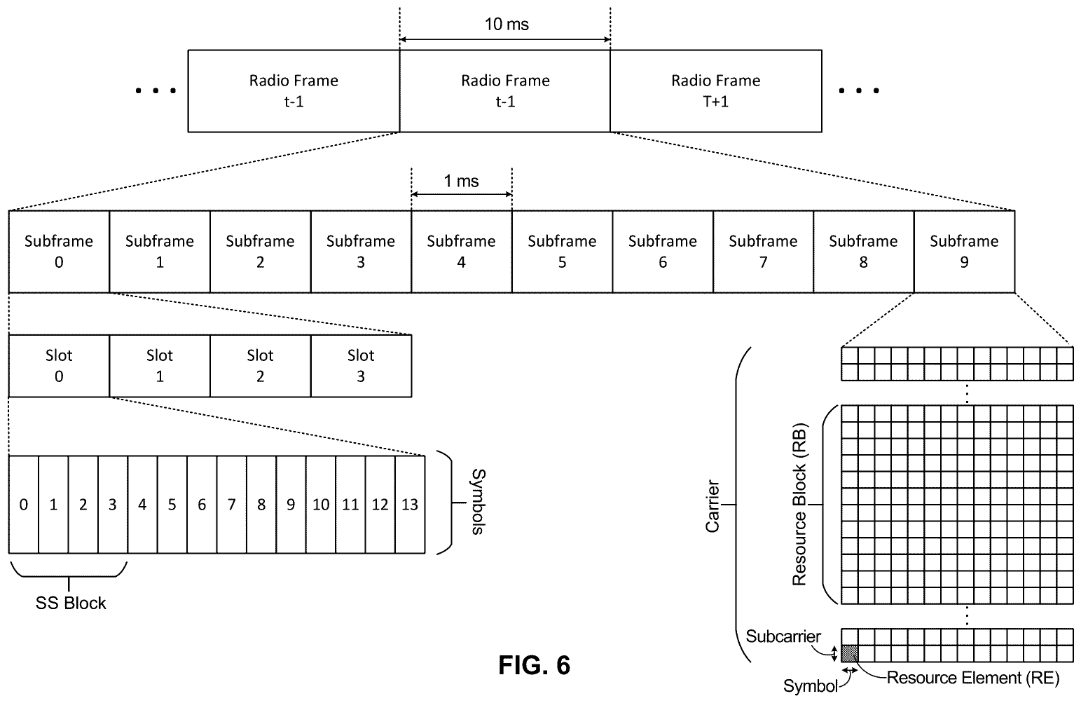

FIG. 6 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 6 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 6. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

In some embodiments, collections of REs may be allocated to a radar reference signal (RS) for use with radar systems as described above. As used herein, a “RF reference signal” or a “radar reference signal” may refer to a type of PRS, or more generally, a reference signal that allows or facilitates measurements and ultimately positioning of a target object (e.g., 310, 406), e.g., in conjunction with assistance data. Radar reference signals may contain, among other things, location data and/or time reference (e.g., time stamp) for measuring or calculating parameters such as R_{T}, R_{R}, Rₛᵤₘ, Tₛᵤₘ, f_{D}), etc. (discussed with respect to FIG. 4). In some implementations, network entities such as base stations and TRPs may broadcast, transmit, or otherwise send (e.g., via unicast) radar reference signals to at least one object including at least one UE.

### Resource Allocation Schemes

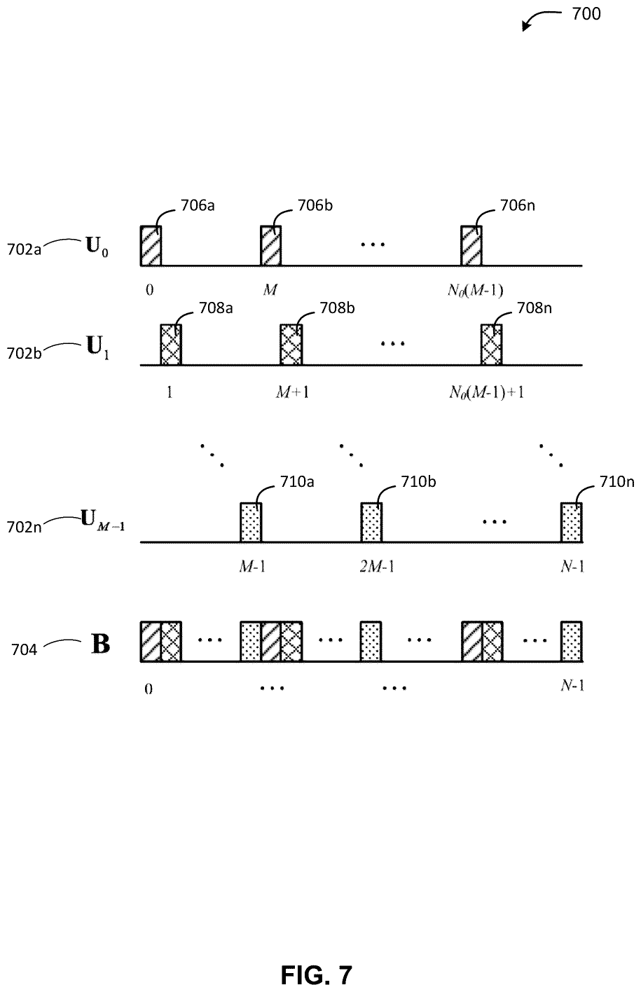

FIG. 7 is diagram showing an example allocation of resources configured according to an OFDM communication scheme to antenna ports of a transmitter configured for MIMO transmission, according to one embodiment. To elaborate briefly, MIMO configurations utilize multiple antenna elements at a transmitter and multiple antenna elements at a corresponding receiver. A MIMO antenna apparatus (e.g., transmitter or receiver) may include more than one physical antenna element. An antenna port may refer to a physical layer associated with a physical antenna element. One resource grid may be associated with each antenna port. However, there may not be a strict mapping (exclusive relations, one-to-one relations, etc.) of antenna ports to physical antenna elements. Rather, the mapping is set according to an implementation. The antenna ports used for transmission of a physical channel or signal may depend on the number of antenna ports configured for the physical channel or signal, and may be configured accordingly (including dynamically, as further discussed below). Multiple transmissions may be input into a propagation channel and multiple signal may be received out of the propagation channel. For example, 4×4 MIMO may use four (4) antenna ports for transmission and four (4) antenna ports for reception. An unequal number of antenna ports at the transmitter and the receiver may be used (e.g., 2×4 MIMO, 4×2 MIMO). MIMO may be distinguished from single input, single output (SISO), single input, multiple output (SIMO), and multiple input, single output (MISO).

Consider a transmitter that includes an array of antenna elements which supports MIMO radar transmission. This transmitter may be included at UE 105, base station 120 or AP 130 of FIG. 1; gNB 210 or eNB 214 of FIG. 2; transmitter array 335; transmitter 402; or transmitter 502. This array of antennas may use a plurality of antenna ports, e.g., M number of antenna ports. A resource grid (e.g., one or more RBs) may be assigned for each antenna port. Depending on implementation, an antenna port may be mapped to a single physical antenna or multiple physical antennas. Thus, an antenna port may not necessarily correspond one to one with an antenna element.

In various embodiments, the network may allocate OFDM resources for, e.g., RF reference signals, such as radar reference signals. OFDM resources may include, e.g., REs and/or RBs, allocated to each of the M antenna ports in specific interleaving patterns. Refer to the example allocation scheme 700 illustrated in FIG. 7. Antenna ports U₀ 702a, U₁ 702b . . . U_{M-1} 702n of a MIMO transmitter are illustrated. It will be appreciated that more than or fewer than three antenna ports as shown may be utilized according to different implementations, and the three antenna ports are shown for illustrative purposes. A wideband frequency spectrum B 704 representing frequency subcarriers and allocations corresponding at least to antenna ports 702a-702n (as well as any others utilized by the transmitter) is also illustrated. Specifically, B 704 may correspond to an overlap of the spectra for antenna ports 702a-702n across the same given frequency bands.

Spectrum allocations 706, 708 and 710 may be allocated to each of the antenna ports 702a-702n. Depending on the implementation, spectrum allocations 706, 708 and 710 may vary in the number of subcarriers and/or the range or width of frequency (e.g., an RE may occupy 30 kHz). In some embodiments, one spectrum allocation may represent an RE, and each of the spectrum allocations in B 704 may represent an RE. In some other embodiments, one spectrum allocation may represent an RB, and each of the spectrum allocations in B 704 may represent an RB. In yet other embodiments, one spectrum allocation may represent a group of RBs, and each of the spectrum allocations in B 704 may represent an RB group. In certain implementations, however, different types of spectrum allocations may be used for different antenna ports. For example, spectrum allocations 706a-706n may represent REs, while spectrum allocations 708a-708n may represent RBs.

In some embodiments, every Mth RE may be equidistantly allocated (to, e.g., RF reference signals) for a specific antenna port. As shown in FIG. 7, REs may occupy subcarriers 0, M, 2M, and so on until N₀(M−1) for antenna port U₀ 702a, where the REs are equally spaced apart in the frequency domain from one another, and where N₀ is a multiple for the final RE for the antenna port. In some embodiments, each subcarrier may be 30 kHz wide. As one example, if there are four (M=4) antenna ports and 40 REs available for allocation, REs (e.g., 706a, 706b . . . 706n) may occupy subcarriers 0, 4, 8, 12 and so on until N₀*(4−1) (e.g., 36) for antenna port U₀ 702a. Furthermore, antenna port U₁ 702b may similarly include REs (e.g., 708a, 708b . . . 708n) equally spaced apart from one another but in different positions, e.g., 1, 5, 9 . . . 37. The last of the four (4) antenna ports, U₃ (U_{M-1} in this case), may include REs (e.g., 710a, 710b . . . 710n) equally spaced apart in subcarriers 3, 7, 11 . . . N−1, where N=number of REs available for allocation (40 in this case). In the case of U₃, the final RE would thus be allocated to subcarrier 39. Finally, B may represent the combined frequency spectrum based on antenna ports U₀ through U₃. It can be seen that none of the allocations from the antenna ports overlap, resulting in efficient RE-level interleaving of, e.g., resources for RF reference signals with resources for communication data.

In some implementations, every Mth RB may be equidistantly allocated for a specific antenna port. In such implementations, RBs (e.g., 706a, 706b . . . 706n) may be allocated to antenna port U₀ 702a may occupy RB 0, M, 2M, and so on until N₀ (M−1), where the RBs are equally spaced apart from one another, and where N₀ is a multiple for the final RB for the antenna port. Similarly, RBs may be allocated to U₁ and U_{M-1} with equal spacing. In this configuration, none of the allocations from the antenna ports overlap, resulting in efficient RB-level interleaving of, e.g., resources for RF reference signals with resources for communication data.

In some implementations, the above allocation scheme can be expanded to sets or groups of RBs. That is, every Mth RB group may be equidistantly allocated for a specific antenna port. In some cases, each RB group may include the same number of RBs so as to keep the distances consistent in the interleaving of RB groups.

For these implementations to occur, each transmitter may report its antenna array capability or capabilities to, e.g., location server 160 or external client 180. The capabilities associated with the antenna array may include whether MIMO radar transmission is supported, the number of antenna ports supported (M), phase coherence across antenna ports, number of antennas in the transmitter and/or in the array, input and/or output antenna ports, and/or channel coefficients (hₓₓ).

In some embodiments, the specific allocation of RF (e.g., radar) reference signals may be requested “on demand.” That is, prior to obtaining the configuration data relating to the resource allocation, a request to obtain such configuration data may be sent. In some implementations, the request may be sent by a server node (e.g., location server 160 or external client 180) to the transmitter. In some implementations, a request may be sent via the transmitter and require approval or confirmation by the server node. In some implementations, a request that requires approval or confirmation may be sent by a receiver (e.g., at another node in a bistatic or multi-static system, or at the radar system 305 in a monostatic system) to the transmitter. The transmitter may obtain the request and configure the allocation accordingly.

For example, a request to equally allocate REs equidistantly for each antenna port may be received by the transmitter. The transmitter may then allocate REs for RF reference signals accordingly. For such configurations, the transmitter may not need to report its antenna array capability (e.g., number of antenna ports M) explicitly. In some scenarios, equidistant allocation of REs may have greater performance (e.g., support of greater number of antennas, greater efficient usage of resources), while equidistant allocation of RBs or RB groups may be more suitable to simplify the implementation of the transmitter system and hardware, making specific configurations more desirable than others depending on the scenario.

However, in another example, the request may include an instruction to only use certain antenna ports, e.g., a particular portion (or all) of U₀ 702a through U_{M-1} 702n. In this case, the transmitter may have reported its capabilities, e.g., number of antenna ports (M), for selection by the instructing server (e.g., location server 160 or external client 180). Based on the transmitter's capability report, the resource allocation may be optimized accordingly (e.g., according to use scenario as noted above).

Due to the nature of the MIMO transmission (including waveform orthogonality), the transmit signal may occupy the whole band (e.g., B), and thus, the range resolution may not be reduced to any significant extent given the high-bandwidth transmission. Equidistant allocation schemes such as that illustrated in FIG. 7 may be better suited for bistatic or multi-static (as opposed to monostatic) sensing use cases because equidistant allocation may increase the spacing between allocated subcarriers transmitted from a transmitter from ∇_{scs} (distance of subcarrier spacing) to M*∇_{scs}, which in turn may reduce the unambiguous range of sensing signals (e.g., radar reference signals) for monostatic implementations.

As an aside, the “unambiguous range” or “unambiguously measurable range” of a radar may refer to the maximum radar range at which a target object may be located so as to guarantee that the reflected signal from that target corresponds to the most recent transmitted pulse. Typically, the received reflected pulse is assumed to be associated with the most recent transmitted pulse. Objects beyond the unambiguous range may thus appear closer because the received pulse may correspond to the previous transmitted pulse.

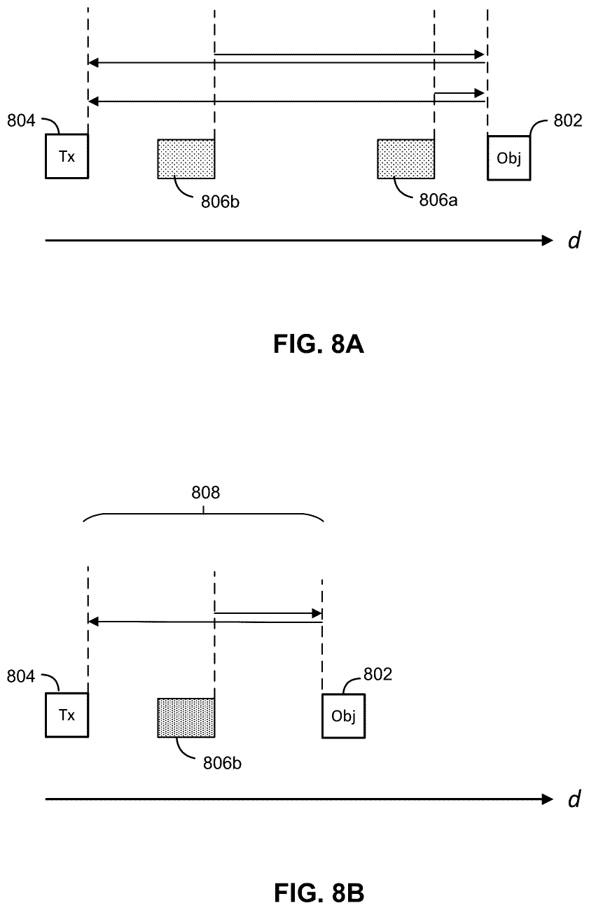

FIGS. 8A and 8B are block diagrams illustrating the effect of a location of an object on the unambiguously measurable range of a target object. Referring to FIG. 8A, an object 802 is positioned at a given location. A transmitter 804 for a monostatic sensing system may attempt to transmit positioning signals and receive reflected positioning signals to determine a time delay between signal transmission and reception (RTT). For example, the transmitter may transmit signal pulses 806a and 806b, as shown in FIGS. 8A and 8B. In the scenario shown in FIG. 8A, the signal pulse 806a has been transmitted before the signal pulse 806b. However, reflected signal pulse for signal pulse 806a will return to the transmitter after the reflected signal pulse for signal pulse 806b, causing the transmitter to recognize it as the reflection of the signal pulse 806b, unless each signal is coded, e.g., with a unique identifier. Ambiguity may be present if, for example, the RTT for a signal pulse is longer than time between pulse repetitions.

Contrast with the scenario of FIG. 8B, where the object 802 is closer to the transmitter 804 as compared to the scenario in FIG. 8A. More specifically, the periodicity between the signal pulses is short enough or the object 802 is close enough such that the reflection of each transmission signal pulse is received before the subsequent transmission signal pulse is transmitted, so there is no confusion as to which pulse the reflection corresponds to. Hence, there is no ambiguity as to the distance of the object. If the distance 808 between the transmitter 804 and the object 802 reaches a point at which ambiguity may arise, it has exceeded the unambiguous range.

Equidistant allocation of OFDM resources may bring advantages, including a simpler allocation scheme, and reduced transmitter and receiver processing capabilities. However, as discussed above, the unambiguously measurable range may be reduced when implemented in a monostatic sensing system.

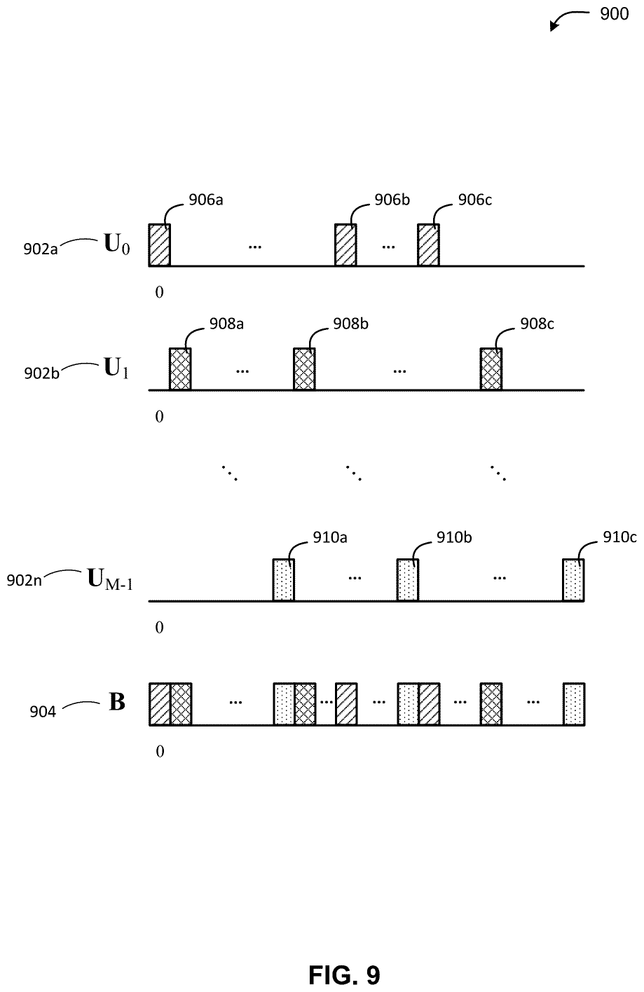

To that end, FIG. 9 is a diagram showing an example allocation of OFDM resources to antenna ports of a transmitter configured for MIMO transmission, according to one embodiment. This transmitter may be included at UE 105, base station 120 or AP 130 of FIG. 1; gNB 210 or eNB 214 of FIG. 2; transmitter array 335; transmitter 402; or transmitter 502. This array of antennas may use a plurality of antenna ports, e.g., M number of antenna ports.

Example allocation scheme 900 provides antenna ports U₀ 902a, U₁ 902b U_{M-1} 902n of a MIMO transmitter, where M=number of antenna ports. It will be appreciated that more than or fewer than three antenna ports as shown may be utilized according to different implementations, and the three antenna ports are shown for illustrative purposes. A combined frequency spectrum B 904 representing frequency subcarriers and their allocations corresponding at least to antenna ports 902a-902n (as well as any others utilized by the transmitter) is also illustrated. Specifically, B 904 may correspond to an overlap of the spectra for antenna ports 902a-902n across the same given frequency bands.

Spectrum allocations 906, 908 and 910 may be allocated to each of the antenna ports 902a-902n. Depending on the implementation, spectrum allocations 706, 708 and 710 may vary in the number of subcarriers and/or the range or width of frequency (e.g., an RE may occupy 30 kHz). Moreover, one spectrum allocation may represent an RE, and RB, or a group of RBs. Each of the allocations in spectrum in B 904 may represent an RE, RB, or group of RBs, although in certain implementations, different types of spectrum allocations may be used for different antenna ports.

In some embodiments, OFDM resources (e.g., REs and/or RBs) may be allocated non-equidistantly for each antenna port. As shown in FIG. 9, REs may occupy at least a first spectrum allocation 906a, a second spectrum allocation 906b, and a third spectrum allocation 906c for antenna port U₀ 902a. However, the spectrum allocations may not be equally spaced apart (as in FIG. 7). Similarly, REs may occupy at least a first spectrum allocation 908a, a second spectrum allocation 908b, and a third spectrum allocation 908c for antenna port U₁ 902b. REs may also occupy at least a first spectrum allocation 910a, a second spectrum allocation 910b, and a third spectrum allocation 910c for antenna port U_{M-1} 902c. According to various embodiments, there may be more than or fewer than three subcarriers per antenna port, which are shown for illustrative purposes.

In some embodiments, each of these spectrum allocations may be spaced apart in the frequency domain by a determined amount or an arbitrary amount relative to another spectrum allocation, subject to maintenance of the unambiguous range (discussed above) and/or in such a way that a frequency spectrum B does not contain overlapping resources. That is to say, in some embodiments, the spacing of the spectrum allocations may not be so arbitrary such that it exceeds the unambiguous range of a transmission channel for an antenna port.

Hence, the allocation of OFDM resources may be non-equidistant, where such a configuration may utilize a non-uniform sampling of distance induced complex exponentials, which maintains the unambiguous range for each transmission channel. In some embodiments, the non-equidistant interleaving of OFDM resources may be changed dynamically, resulting in non-uniform sampling patterns in two dimensions, across the frequency spectrum (e.g., as illustrated in FIG. 9) and also across the time domain. For example, signal pulses transmitted from a transmitter (e.g., pulses 806a and 806b shown in FIGS. 8A and 8B) may be reconfigured to have a different non-equidistant allocation. In various implementations, the reconfiguration may occur periodically, as determined, or at each transmission.

Such non-equidistant allocation of OFDM resources for each antenna port may address the reduced unambiguously measurable range that may manifest in, e.g., equidistant allocation as discussed with respect to FIG. 7. Put another way, there may be less ambiguity in the measurable range of a target object when using non-equidistant allocation. However, the non-equidistant interleaving of FIG. 9 may involve higher processing capability for the radar receiver. For example, fast Fourier transform (FFT)-based processing may not be able to efficiently detect the target object and estimate sensing parameters, e.g., RTT, Doppler frequency associated with the target object, distance to the target object, AoA, the total distance. More specifically, for non-uniform or non-equidistant resource allocation as utilized in the FIG. 9 embodiment, FFT-based processing may lead to increased sidelobes. Further, non-equidistant interleaving may use higher-complexity range estimation processing, e.g., based on compressed sensing. Thus, in some embodiments, the radar receiver may report its capabilities for target detection and parameter estimation when or utilizing non-equidistant resource allocation (or non-uniform frequency-domain-sampled OFDM waveforms).

In some embodiments, an “on demand” request of a specific non-uniform resource allocation pattern for interleaving RF reference signals and data communication signals may be initiated jointly from the transmitter and the receiver in order to utilize processing capability at the receiver side as well. That is, in some implementations, a request may be sent by the receiver (e.g., at another node in a bistatic or multi-static system, or at the radar system 305 in a monostatic system) to the transmitter. The request may include the aforementioned receiver capabilities. In some implementations, the request may be sent by a server node (e.g., location server 160 or external client 180) to the transmitter. The transmitter may obtain the request and configure the allocation accordingly.

In other embodiments, the allocation of OFDM resources may be dynamically changed over time or across instances of an RF sensing reference signal. For example, in a network environment or service environment has changed, the radar system may determine a different resource allocation; e.g., if the target object is within a threshold range associated with an unambiguously measurable range of the target object (e.g., determined based on a comparison of RTT to the object with signal pulse interval), then the transmitter may configure an equidistant allocation of resources in order to, e.g., reduce computational complexity. In various implementations, resource allocations or mappings may be signaled, e.g., by a server node to the transmitter, through Downlink Control Information (DCI), Radio Resource Control (RRC) protocol, NRPPa, or LPP. In contrast, if the network environment or service environment maintains substantially same or similar requirements, then the resource allocation may be static.

In some embodiments, to coexist with non-sensing data communications, a network may coordinate RF sensing nodes (e.g., access point, radar system) and communication nodes (e.g., access point, UE) for the allocation of time/frequency resources according to, e.g., antenna usage. For instance, at a given time, the available antenna ports for sensing or the number thereof may change or have a need to change. Hence, the RF sensing resource allocation (e.g., allocation of resources to subcarriers as shown in FIG. 7 or 9) may be jointly considered with data communication resource allocation (e.g., allocation of resources to subcarriers not shown in FIG. 7 or 9, between the resources as shown). For example, if fewer antenna ports are available, more RF sensing resources may be allocated for a given antenna port, and vice versa.

In some embodiments, all of the antenna ports may be configured to transmit the resources as illustrated in FIG. 7 or 9 within the same symbol (i.e., time domain). In other words, the MIMO antenna(s) of the transmitter may transmit the resources simultaneously, within the same symbol, in the same frequency band. Time-domain multiplexing of the resources, as opposed to frequency-domain multiplexing as shown in FIGS. 7 and 9, may not maximize the coherent transmission gain for the MIMO antenna.

### Techniques for Resource Allocation

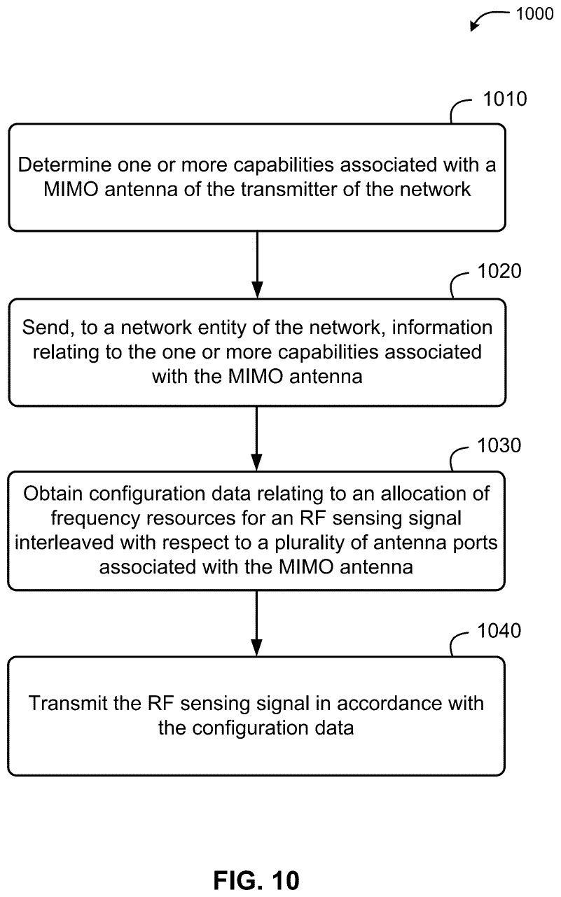

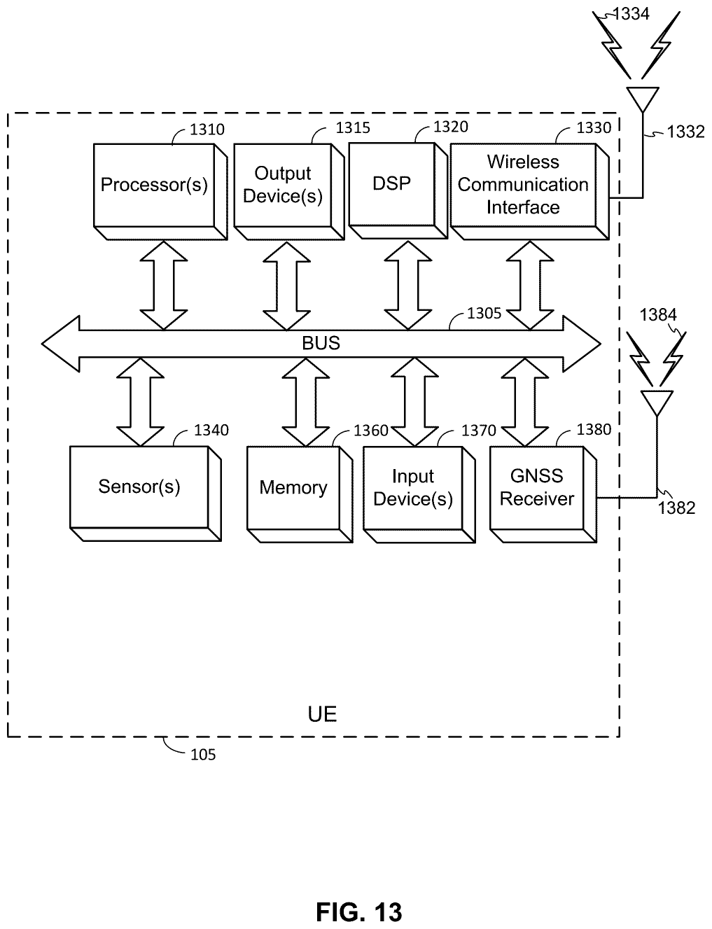

FIG. 10 is a flow diagram of a method 1000 of allocating resources for RF sensing by a transmitter of a network, according to some embodiments. Means for performing the functionality illustrated in one or more of the blocks shown in FIG. 10 may be performed by hardware and/or software components of a base station or a TRP (or, in certain implementations, by a UE). Example components of a base station are illustrated in FIG. 12, which are described in more detail below. Example components of a UE are illustrated in FIG. 13, which are described in more detail below. It should also be noted that the operations of the method 1000 may be performed in any suitable order, not necessarily the order depicted in FIG. 10. Further, the method 1000 may include additional or fewer operations than those depicted in FIG. 10 to accomplish the resource allocation.

At step 1010, the functionality of method 1000 may include determining one or more capabilities associated with a multiple input, multiple output (MIMO) antenna of a transmitter of a network. In some embodiments, the network may be an example of the positioning system 100 of FIG. 1 or the positioning system 100 of FIG. 2. In some embodiments, the transmitter may be an example of the transmitter circuitry 325 of FIG. 3, which may be in signal communication with one or more antennas, including at least one MIMO antenna. In some embodiments, the transmitter may determine the capabilities. The transmitter may be disposed in a base station (e.g., base station 120, gNB 210), access point (e.g., AP 130), or UE (e.g., 105).

In some implementations, each MIMO antenna may include more than one antenna element, each antenna element associated with one or more antenna ports. In some embodiments, the one or more capabilities may include whether MIMO radar transmission is supported, the number of antenna ports supported (M), phase coherence across antenna ports, number of antennas in the transmitter and/or in an array of the transmitter, input and/or output antenna ports, and/or channel coefficients (hₓₓ). In some embodiments, the transmitter may be utilized in a monostatic radar system having a transmitter and a receiver at the same node (such as in FIG. 3), or a bistatic or multi-static radar system having a transmitter and a receiver in different nodes (such as the two different base stations in FIGS. 4 and 5).

At step 1020, the functionality of method 1000 may include sending, to a network entity of the network, information relating to the one or more capabilities associated with the MIMO antenna. In some embodiments, the network entity may be a server node, e.g., a location server 160 or an external client 180. The location server 160 may be configured to, e.g., provide or exchange data with, facilitate location measurement by, and/or facilitate location determination by, e.g., a UE, an AP, and/or a base station. The external client 180 may be a web server or remote application that may have some association with UE 105 (e.g. may be accessed by a user of UE 105) or may be a server, application, or computer system providing a location service to some other user or users. In some embodiments, the transmitter may send capability information of the MIMO antenna to, e.g., the location server.

In some embodiments, the network entity may be another base station (or AP, UE, etc.), such as one that includes a receiver. In some embodiments, the network entity may be the same base station (or AP, UE, etc.) that is using the transmitter. That is, the capability information may be sent to itself, or more specifically, another portion of the base station, such as a subsystem comprising instructions for allocating resources or configuring the allocation.

At step 1030, the functionality of method 1000 may include obtaining configuration data relating to an allocation of frequency resources for a radio frequency (RF) sensing signal interleaved with respect to a plurality of antenna ports associated with the MIMO antenna. According to different embodiments, the resources may be configured according to an orthogonal frequency-division multiplexing (OFDM) communication scheme, e.g., allocated to REs, RBs, or RB groups as discussed with respect to FIGS. 7 and 9. In some embodiments, the transmitted RF sensing signal may include a radar sensing signal or radar reference signal, and the radar sensing/reference signal (or data associated therewith) may be allocated to REs or RBs (e.g., for transmission by the transmitter). In some embodiments, the obtained configuration data may be configured based on the one or more capabilities associated with the MIMO antenna (from step 1010).

In some embodiments, the allocation of frequency resources may be equidistant for each antenna port, such as the allocation scheme illustrated in FIG. 7. For example, REs for an antenna port may be allocated to every Mth subcarrier, where M=number of antenna ports. In some embodiments, the allocation of frequency resources may be non-equidistant for each antenna port, such as the allocation scheme illustrated in FIG. 9.

In some embodiments, the allocation of frequency resources may be “on demand,” e.g., according to a request sent or approved by the server node. In some embodiments, the interleaving of resources may result in a combined frequency band, and the combined band may be transmitted simultaneously within the same symbol (i.e., time domain) by the MIMO antenna.

At step 1040, the functionality of method 1000 may include transmitting the RF sensing signal in accordance with the configuration data. In some embodiments, the RF sensing signal may be transmitted from, e.g., a base station or access point, via the transmitter.

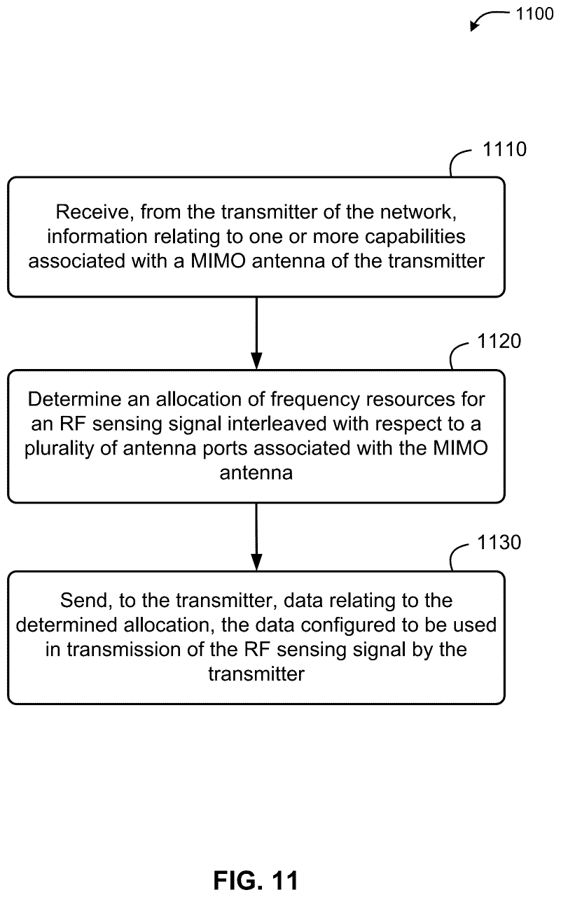

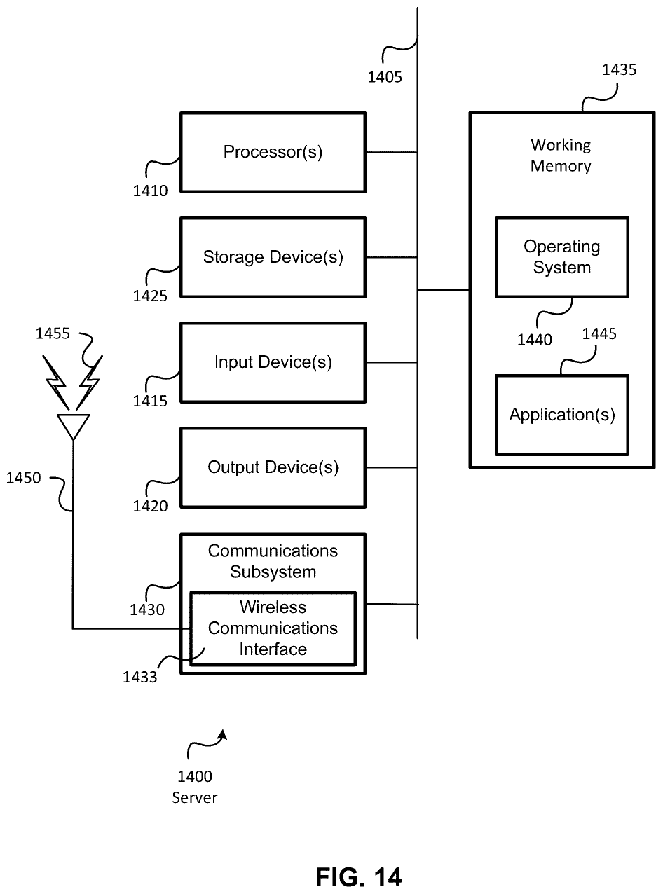

FIG. 11 is a flow diagram of a method 1100 of allocating resources for RF sensing within a network, according to some embodiments. Means for performing the functionality illustrated in one or more of the blocks shown in FIG. 11 may be performed by hardware and/or software components of a server node, such as a location server 160 or an external client 180. Example components of a server node are illustrated in FIG. 14, which is described in more detail below. It should also be noted that the operations of the method 1100 may be performed in any suitable order, not necessarily the order depicted in FIG. 11. Further, the method 1100 may include additional or fewer operations than those depicted in FIG. 11 to accomplish the resource allocation.

At step 1110, the functionality of method 1100 may include receiving, from a transmitter of a network, information relating to one or more capabilities associated with a multiple input, multiple output (MIMO) antenna of the transmitter. In some embodiments, the network may be an example of the positioning system 100 of FIG. 1 or the positioning system 100 of FIG. 2. In some embodiments, the transmitter may be an example of the transmitter circuitry 325 of FIG. 3. In some embodiments, a server node (e.g., location server 160 or external client 180) of the network may receive the information relating to the capabilities.

In some implementations, each MIMO antenna may include more than one antenna element, each antenna element associated with one or more antenna ports. In some embodiments, the one or more capabilities may include whether MIMO radar transmission is supported, the number of antenna ports supported (M), phase coherence across antenna ports, number of antennas in the transmitter and/or in an array of the transmitter, input and/or output antenna ports, and/or channel coefficients (hₓₓ).

At step 1120, the functionality of method 1100 may include determining an allocation of frequency resources for a radio frequency (RF) sensing signal interleaved with respect to a plurality of antenna ports associated with the MIMO antenna. According to different embodiments, the frequency resources configured according to an orthogonal frequency-division multiplexing (OFDM) communication scheme, e.g., allocated to REs, RBs, or RB groups as discussed with respect to FIGS. 7 and 9. In some embodiments, the transmitted RF sensing signal may include a radar sensing signal or radar reference signal, and the radar sensing/reference signal (or data associated therewith) may be allocated to REs or RBs (e.g., for transmission by the transmitter). In some embodiments, the allocation of resources may be determined based on the one or more capabilities associated with the MIMO antenna (from step 1110).

In some embodiments, the allocation of frequency resources may be equidistant for each antenna port, such as the allocation scheme illustrated in FIG. 7. For example, REs may be allocated to every Mth subcarrier, where M=number of antenna ports. In some embodiments, the allocation of frequency resources may be non-equidistant for each antenna port, such as the allocation scheme illustrated in FIG. 9. In some embodiments, the allocation of frequency resources may be “on demand,” e.g., according to a request sent via the transmitter (e.g., from a base station, access point, or UE) to be approved by the server node.

At step 1130, the functionality of method 1100 may include sending, to the transmitter, data relating to the determined allocation, the data configured to be used in transmission of the RF sensing signal by the transmitter. The sending may occur via the network.

### Apparatus

FIG. 12 illustrates an embodiment of a base station 120, which can be utilized as described herein above (e.g., in association with FIGS. 7-11). For example, a transmitter of the base station 120 can perform one or more of the functions of the methodology shown in FIG. 10. It should be noted that FIG. 12 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1205 (or may otherwise be in communication, as appropriate). The hardware elements may include a processor(s) 1210 which can include without limitation one or more general-purpose processors, one or more special-purpose processors (such as DSP chips, graphics acceleration processors, ASICs, and/or the like), and/or other processing structure or means. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1230 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1232 that send and/or receive wireless signals 1234.

The base station 120 may also include a network interface 1280, which can include support of wireline communication technologies. The network interface 1280 may include a modem, network card, chipset, and/or the like. The network interface 1280 may include one or more input and/or output communication interfaces to permit data to be exchanged with a network, communication network servers, computer systems, and/or any other electronic devices described herein.

In many embodiments, the base station 120 may further comprise a memory 1260. The memory 1260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1260 of the base station 120 also may comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the base station 120 (and/or processor(s) 1210 or DSP 1220 within base station 120). In some embodiments, then, such code and/or instructions can be used to configure and/or adapt a general-purpose computer (or other device) to perform one or more operations in accordance with the described methods.

FIG. 13 is a block diagram of an embodiment of a UE 105, which can be utilized as described herein above (e.g., in association with FIGS. 7-11). For example, the UE 105 can perform, and/or be utilized in conjunction with, one or more of the functions of the methodology shown in FIG. 10. For instance, a UE supporting MIMO radar may be configured to perform the aforementioned methodology. It should be noted that FIG. 13 is meant only to provide a generalized illustration of various components, any or all of which may be utilized as appropriate. It can be noted that, in some instances, components illustrated by FIG. 13 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 13.

The UE 105 is shown comprising hardware elements that can be electrically coupled via a bus 1305 (or may otherwise be in communication, as appropriate). The hardware elements may include a processor(s) 1310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1310 may comprise one or more processing units, which may be housed in a single integrated circuit (IC) or multiple ICs. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below). The UE 105 also can include one or more input devices 1370, which can include without limitation one or more keyboards, touch screens, touch pads, microphones, buttons, dials, switches, and/or the like; and one or more output devices 1315, which can include without limitation one or more displays (e.g., touch screens), light emitting diodes (LEDs), speakers, and/or the like.

The UE 105 may also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1330 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1332 that send and/or receive wireless signals 1334. According to some embodiments, the wireless communication antenna(s) 1332 may comprise a plurality of discrete antennas, antenna arrays, or any combination thereof. The antenna(s) 1332 may be capable of transmitting and receiving wireless signals using beams (e.g., Tx beams and Rx beams). Beam formation may be performed using digital and/or analog beam formation techniques, with respective digital and/or analog circuitry. The wireless communication interface 1330 may include such circuitry.

Depending on desired functionality, the wireless communication interface 1330 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1340. Sensor(s) 1340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1380 capable of receiving signals 1384 from one or more GNSS satellites using an antenna 1382 (which could be the same as antenna 1332). Positioning based on GNSS signal measurement can be utilized to complement and/or incorporate the techniques described herein. The GNSS receiver 1380 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1380 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1380 is illustrated in FIG. 13 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1310, DSP 1320, and/or a processor within the wireless communication interface 1330 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1310 or DSP 1320.

The UE 105 may further include and/or be in communication with a memory 1360. The memory 1360 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the UE 105 also can comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the UE 105 (and/or processor(s) 1310 or DSP 1320 within UE 105). In some embodiments, then, such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of one or more network components as described in the embodiments herein (e.g., location server 160 or external client 180 of FIG. 1). For example, the location server 160 can perform, and/or be utilized in conjunction with, one or more of the functions of the methodology shown in FIG. 11. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device, computerized network apparatus, and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of allocating resources for radio frequency (RF) sensing by a transmitter of a network, the method comprising: determining one or more capabilities associated with a multiple input, multiple output (MIMO) antenna of the transmitter of the network; sending, to a network entity of the network, information relating to the one or more capabilities associated with the MIMO antenna; obtaining configuration data relating to an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the obtained data configured based on the one or more capabilities associated with the MIMO antenna; and transmitting the RF sensing signal in accordance with the configuration data.

Clause 2: The method of clause 1, wherein: the obtaining of the configuration data comprises obtaining the configuration data from the network entity; and the configuration data comprises an allocation of resource elements or resource blocks to the plurality of antenna ports, within at least a frequency domain of the OFDM communication scheme.

Clause 3: The method of any of clauses 1-2 wherein the configuration data comprises an indication of an equidistant allocation of the resource elements or the resource blocks to the plurality of antenna ports, such that the resource elements or the resource blocks do not overlap within a combined frequency spectrum associated with the plurality of antenna ports.

Clause 4: The method of any of clauses 1-3 further comprising, prior to the obtaining the configuration data relating to the frequency resources for the RF sensing signal, sending a request to the network entity for a prescribed allocation of the resource elements or the resource blocks to the plurality of antenna ports, such that the resource elements or the resource blocks do not overlap within a combined frequency spectrum associated with the plurality of antenna ports.

Clause 5: The method of any of clauses 1-4 wherein the configuration data comprises an indication of a non-equidistant allocation of the resource elements or the resource blocks to the plurality of antenna ports, such that the resource elements or the resource blocks do not overlap within a combined frequency spectrum associated with the plurality of antenna ports.

Clause 6: The method of any of clauses 1-5 wherein the obtaining of the configuration data comprises: determining an allocation of resource elements, resource blocks, or a combination thereof to the plurality of antenna ports; sending an indication of the determined allocation to the network entity; and receiving a confirmation for the determined allocation from the network entity.

Clause 7: The method of any of clauses 1-6 wherein the one or more capabilities comprise one or more of a number of the antenna ports associated with the transmitter, or a phase coherence across the antenna ports.

Clause 8: The method of any of clauses 1-7 wherein the RF sensing signal comprises a radar reference signal, the radar reference signals configured to facilitate positioning of an object.

Clause 9: The method of any of clauses 1-8 further comprising performing positioning of a target object based at least on the transmitted RF sensing signal.

Clause 10: The method of any of clauses 1-9 wherein the network entity comprises: a location server of the network; or a base station comprising the transmitter of the network.

Clause 11: A base station, comprising: a transmitter, the transmitter comprising a multiple input, multiple output (MIMO) antenna; memory; and one or more processors communicatively coupled to the memory and the transmitter, and configured to: determine one or more capabilities associated with the MIMO antenna of the transmitter; send, to a network entity of a network, information relating to the one or more capabilities associated with the MIMO antenna; obtain configuration data relating to an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the obtained data configured based on the one or more capabilities associated with the MIMO antenna; and transmit the RF sensing signal in accordance with the configuration data.

Clause 12: The base station of clause 11, wherein: the obtaining of the configuration data comprises obtaining the configuration data from the network entity; and the configuration data comprises an allocation of resource elements or resource blocks to the plurality of antenna ports, within at least a frequency domain of the OFDM communication scheme.

Clause 13: The base station of any of clauses 11-12 wherein the configuration data comprises an indication of an equidistant allocation of the resource elements or the resource blocks to the plurality of antenna ports.

Clause 14: The base station of any of clauses 11-13 wherein the one or more processors are further configured to, prior to the obtaining the configuration data relating to the frequency resources for the RF sensing signal, send a request to the network entity for a prescribed allocation of the resource elements or the resource blocks to the plurality of antenna ports, the prescribed allocation comprising the equidistant allocation.

Clause 15: The base station of any of clauses 11-14 wherein the configuration data comprises an indication of a non-equidistant allocation of the resource elements or the resource blocks to the plurality of antenna ports.

Clause 16: The base station of any of clauses 11-15 wherein the one or more capabilities comprise one or more of a number of the antenna ports associated with the transmitter, or a phase coherence across the antenna ports.

Clause 17: The base station of any of clauses 11-16 wherein the RF sensing signal comprises a radar reference signal, the radar reference signals configured to facilitate positioning of an object; and the one or more processors are further configured to perform positioning of a target object based at least on the transmitted RF sensing signal.

Clause 18: The base station of any of clauses 11-17 wherein the network entity comprises: a location server of the network; or a base station comprising the transmitter of the network.

Clause 19: A method of allocating resources for radio frequency (RF) sensing within a network, the method comprising: receiving, from a transmitter of the network, information relating to one or more capabilities associated with a multiple input, multiple output (MIMO) antenna of the transmitter; determining an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the allocation determined based on the one or more capabilities associated with the MIMO antenna; and sending, to the transmitter, data relating to the determined allocation, the data configured to be used in transmission of the RF sensing signal by the transmitter.

Clause 20: The method of clause 19, wherein the one or more capabilities comprise one or more of a number of the antenna ports associated with the transmitter, or a phase coherence across the antenna ports.

Clause 21: The method of any of clauses 19-20 wherein the determining of the allocation of frequency resources comprises determining an allocation of resource elements or resource blocks to the plurality of antenna ports, within at least a frequency domain of the OFDM communication scheme.

Clause 22: The method of any of clauses 19-21 wherein the determining of the allocation of resource elements or the resource blocks comprises determining an equidistant allocation of the resource elements or the resource blocks, such that the resource elements or the resource blocks do not overlap within a combined frequency spectrum associated with the plurality of antenna ports.

Clause 23: The method of any of clauses 19-22 wherein the determining of the allocation of resource elements or the resource blocks comprises determining a non-equidistant allocation of the resource elements or the resource blocks, such that the resource elements or the resource blocks do not overlap within a combined frequency spectrum associated with the plurality of antenna ports.

Clause 24: The method of any of clauses 19-23 wherein the RF sensing signal comprises a radar reference signal, the radar reference signals configured to facilitate positioning of an object; and the method further comprises causing the transmitter to perform positioning of a target object based at least on the transmitted RF sensing signal.

Clause 25: A computerized network apparatus, comprising: one or more network interfaces configured to perform data communication with a transmitter of a network; memory; and one or more processors communicatively coupled to the memory and the one or more network interfaces, and configured to: receive, from the transmitter of the network, information relating to one or more capabilities associated with a multiple input, multiple output (MIMO) antenna of the transmitter; determine an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the allocation determined based on the one or more capabilities associated with the MIMO antenna; and send, to the transmitter, data relating to the determined allocation, the data configured to be used in transmission of the RF sensing signal by the transmitter.

Clause 26: The computerized network apparatus of clause 25, wherein the one or more capabilities comprise one or more of a number of the antenna ports associated with the transmitter, or a phase coherence across the antenna ports.

Clause 27: The computerized network apparatus of any of clauses 25-26 wherein the determination of the allocation of frequency resources comprises a determination of an allocation of resource elements or resource blocks to the plurality of antenna ports, within at least a frequency domain of the OFDM communication scheme.

Clause 28: The computerized network apparatus of any of clauses 25-27 wherein the determination of the allocation of resource elements or the resource blocks comprises a determination of an equidistant allocation of the resource elements or the resource blocks, such that the resource elements or the resource blocks do not overlap within a combined frequency spectrum associated with the plurality of antenna ports.

Clause 29: The computerized network apparatus of any of clauses 25-28 wherein the determination of the allocation of resource elements or the resource blocks comprises a determination of a non-equidistant allocation of the resource elements or the resource blocks, such that the resource elements or the resource blocks do not overlap within a combined frequency spectrum associated with the plurality of antenna ports.

Clause 30: The computerized network apparatus of any of clauses 25-29 wherein the RF sensing signal comprises a radar reference signal, the radar reference signals configured to facilitate positioning of an object; and the one or more processors is further configured to cause the transmitter to perform positioning of a target object based at least on the transmitted RF sensing signal.

What is claimed is:

1. A method of allocating resources for radio frequency (RF) sensing by a transmitter of a network, the method comprising:
determining one or more capabilities associated with a multiple input, multiple output (MIMO) antenna of the transmitter of the network;
sending, to a network entity of the network, information relating to the one or more capabilities associated with the MIMO antenna;
obtaining configuration data relating to an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the obtained data configured based on the one or more capabilities associated with the MIMO antenna; and
transmitting the RF sensing signal in accordance with the configuration data.

2. The method of claim 1, wherein:
the obtaining of the configuration data comprises obtaining the configuration data from the network entity; and
the configuration data comprises an allocation of resource elements or resource blocks to the plurality of antenna ports, within at least a frequency domain of the OFDM communication scheme.

3. The method of claim 2, wherein the configuration data comprises an indication of an equidistant allocation of the resource elements or the resource blocks to the plurality of antenna ports, such that the resource elements or the resource blocks do not overlap within a combined frequency spectrum associated with the plurality of antenna ports.

4. The method of claim 3, further comprising, prior to the obtaining the configuration data relating to the frequency resources for the RF sensing signal, sending a request to the network entity for a prescribed allocation of the resource elements or the resource blocks to the plurality of antenna ports, such that the resource elements or the resource blocks do not overlap within a combined frequency spectrum associated with the plurality of antenna ports.

5. The method of claim 2, wherein the configuration data comprises an indication of a non-equidistant allocation of the resource elements or the resource blocks to the plurality of antenna ports, such that the resource elements or the resource blocks do not overlap within a combined frequency spectrum associated with the plurality of antenna ports.

6. The method of claim 1, wherein the obtaining of the configuration data comprises:
determining an allocation of resource elements, resource blocks, or a combination thereof to the plurality of antenna ports;
sending an indication of the determined allocation to the network entity; and
receiving a confirmation for the determined allocation from the network entity.

7. The method of claim 1, wherein the one or more capabilities comprise one or more of a number of the antenna ports associated with the transmitter, or a phase coherence across the antenna ports.

8. The method of claim 1, wherein the RF sensing signal comprises a radar reference signal, the radar reference signals configured to facilitate positioning of an object.

9. The method of claim 1, further comprising performing positioning of a target object based at least on the transmitted RF sensing signal.

10. The method of claim 1, wherein the network entity comprises:
a location server of the network; or
a base station comprising the transmitter of the network.

11. A base station, comprising:
a transmitter, the transmitter comprising a multiple input, multiple output (MIMO) antenna;
memory; and
one or more processors communicatively coupled to the memory and the transmitter, and configured to:
determine one or more capabilities associated with the MIMO antenna of the transmitter;
send, to a network entity of a network, information relating to the one or more capabilities associated with the MIMO antenna;
obtain configuration data relating to an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the obtained data configured based on the one or more capabilities associated with the MIMO antenna; and
transmit the RF sensing signal in accordance with the configuration data.

12. The base station of claim 11, wherein:
the obtaining of the configuration data comprises obtaining the configuration data from the network entity; and
the configuration data comprises an allocation of resource elements or resource blocks to the plurality of antenna ports, within at least a frequency domain of the OFDM communication scheme.

13. The base station of claim 12, wherein the configuration data comprises an indication of an equidistant allocation of the resource elements or the resource blocks to the plurality of antenna ports.

14. The base station of claim 13, wherein the one or more processors are further configured to, prior to the obtaining the configuration data relating to the frequency resources for the RF sensing signal, send a request to the network entity for a prescribed allocation of the resource elements or the resource blocks to the plurality of antenna ports, the prescribed allocation comprising the equidistant allocation.

15. The base station of claim 12, wherein the configuration data comprises an indication of a non-equidistant allocation of the resource elements or the resource blocks to the plurality of antenna ports.

16. The base station of claim 11, wherein the one or more capabilities comprise one or more of a number of the antenna ports associated with the transmitter, or a phase coherence across the antenna ports.

17. The base station of claim 11, wherein:
the RF sensing signal comprises a radar reference signal, the radar reference signals configured to facilitate positioning of an object; and
the one or more processors are further configured to perform positioning of a target object based at least on the transmitted RF sensing signal.

18. The base station of claim 11, wherein the network entity comprises:
a location server of the network; or
a base station comprising the transmitter of the network.

19. A method of allocating resources for radio frequency (RF) sensing within a network, the method comprising:
receiving, from a transmitter of the network, information relating to one or more capabilities associated with a multiple input, multiple output (MIMO) antenna of the transmitter;
determining an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the allocation determined based on the one or more capabilities associated with the MIMO antenna; and
sending, to the transmitter, data relating to the determined allocation, the data configured to be used in transmission of the RF sensing signal by the transmitter.

20. The method of claim 19, wherein the one or more capabilities comprise one or more of a number of the antenna ports associated with the transmitter, or a phase coherence across the antenna ports.

21. The method of claim 19, wherein the determining of the allocation of frequency resources comprises determining an allocation of resource elements or resource blocks to the plurality of antenna ports, within at least a frequency domain of the OFDM communication scheme.

22. The method of claim 21, wherein the determining of the allocation of resource elements or the resource blocks comprises determining an equidistant allocation of the resource elements or the resource blocks, such that the resource elements or the resource blocks do not overlap within a combined frequency spectrum associated with the plurality of antenna ports.

23. The method of claim 21, wherein the determining of the allocation of resource elements or the resource blocks comprises determining a non-equidistant allocation of the resource elements or the resource blocks, such that the resource elements or the resource blocks do not overlap within a combined frequency spectrum associated with the plurality of antenna ports.

24. The method of claim 21, wherein:
the RF sensing signal comprises a radar reference signal, the radar reference signals configured to facilitate positioning of an object; and
the method further comprises causing the transmitter to perform positioning of a target object based at least on the transmitted RF sensing signal.

25. A computerized network apparatus, comprising:
one or more network interfaces configured to perform data communication with a transmitter of a network;
memory; and
one or more processors communicatively coupled to the memory and the one or more network interfaces, and configured to:
receive, from the transmitter of the network, information relating to one or more capabilities associated with a multiple input, multiple output (MIMO) antenna of the transmitter;
determine an allocation of frequency resources for an RF sensing signal, the frequency resources interleaved with respect to a plurality of antenna ports associated with the MIMO antenna, the frequency resources configured according to an orthogonal frequency-division multiplexing (OFDM) communication scheme, the allocation determined based on the one or more capabilities associated with the MIMO antenna; and
send, to the transmitter, data relating to the determined allocation, the data configured to be used in transmission of the RF sensing signal by the transmitter.

26. The computerized network apparatus of claim 25, wherein the one or more capabilities comprise one or more of a number of the antenna ports associated with the transmitter, or a phase coherence across the antenna ports.

27. The computerized network apparatus of claim 25, wherein the determination of the allocation of frequency resources comprises a determination of an allocation of resource elements or resource blocks to the plurality of antenna ports, within at least a frequency domain of the OFDM communication scheme.

28. The computerized network apparatus of claim 27, wherein the determination of the allocation of resource elements or the resource blocks comprises a determination of an equidistant allocation of the resource elements or the resource blocks, such that the resource elements or the resource blocks do not overlap within a combined frequency spectrum associated with the plurality of antenna ports.

29. The computerized network apparatus of claim 27, wherein the determination of the allocation of resource elements or the resource blocks comprises a determination of a non-equidistant allocation of the resource elements or the resource blocks, such that the resource elements or the resource blocks do not overlap within a combined frequency spectrum associated with the plurality of antenna ports.

30. The computerized network apparatus of claim 25, wherein:
the RF sensing signal comprises a radar reference signal, the radar reference signals configured to facilitate positioning of an object; and
the one or more processors is further configured to cause the transmitter to perform positioning of a target object based at least on the transmitted RF sensing signal.
